(19) United States
(12) Patent Application Publication
(10) Pub. No.: US 2004/0230076 A1
(43) Pub. Date: Nov. 18, 2004

(54) Process for purification of zoledronic acid

(76) Inventors: Revital Lifshitz-Liron, Herzlia (IL); Ramy Lidor-Hadas, Kfar Saba (IL)

Correspondence Address: KENYON & KENYON, ONE BROADWAY, NEW YORK, NY, 10004, US

(21) Appl. No.: 10/789,821

(22) Filed: Feb. 27, 2004

Related U.S. Application Data
(60) Provisional application No. 60/449,837, filed on Feb. 27, 2003.

(51) Int. Cl. C07F 9/28

(52) U.S. Cl. 562/22

(57) ABSTRACT

The invention relates to processes for preparing and purifying zoledronic acid.

### CROSS-REFERENCE TO RELATED APPLICATION

This application claims the benefit of the U.S. Provisional Application Serial No. 60/449,837, filed Feb. 27, 2003, the content of which is incorporated herein.

### FIELD OF THE INVENTION

The invention relates to processes for preparing and purifying zoledronic acid.

### BACKGOUND OF THE INVENTION

Zoledronic acid is a third-generation bisphosphonate characterized by a side chain that includes an imidazole ring. It inhibits osteoclast bone resorption and is used for the treatment of tumor-induced hypercalcemia. Zometa® (Zoledronic acid for injection) is indicated for the treatment of patients with multiple myeloma and patients with documented bone metastases from prostate cancer, lung cancer, breast cancer and other solid tumor types, in conjunction with standard antineoplastic therapy. Zometa® is available in vials as a sterile powder for solution for intravenous infusion. One vial contains 4 mg of Zoledronic acid (anhydrous), corresponding to 4.264 mg of Zoledronic acid monohydrate.

Early studies, supported by Novartis (the manufacturer of both Pamidronate and Zoledronic acid), have indicated that Zoledronic acid is more potent and probably more effective than earlier drugs in this general class, including Etidronate, Alendronate and Pamidronate. Furthermore, because of the lower dose required, it can be safely administered over a much shorter period of time.

The empirical formula for Zoledronic acid monohydrate is: C₅H₁₀N₂O₇P₂.H₂O. The chemical name of Zoledronic acid is 2-(imidazol-1-yl)-1-hydroxy-ethane-1,1-diphosphonic acid. The chemical structure of Zoledronic acid monohydrate is the following:

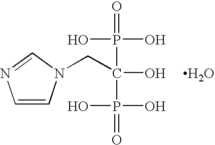

Zoledronic acid is a white crystalline powder. The melting point of Zoledronic acid is 239° C. (dec.). It is highly soluble in 0.1N Sodium hydroxide solution, sparingly soluble in water and 0.1N Hydrochloric acid, and practically insoluble in organic solvents. The pH of a 0.7% solution of Zoledronic acid in water is approximately 2.0.

U.S. Pat. No. 4,939,130 discloses zoledronic acid and a process for making zoledronic acid, based on a per-se known method that was published by Kabachnick et. al. [Izv. Akad. Nauk. USSR, Ser. Khim., 2, 433-437, (1987)], (see example 10):

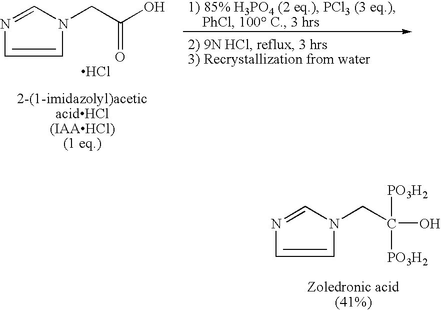

The final step of recrystallization from water (3) is the purification step that gives Zoledronic acid monohydrate.

### SUMMARY OF THE INVENTION

The invention provides a process for the purification of crude Zoledronic acid by alkalization and re-acidification of an aqueous solution of Zoledronic acid.

### DETAILED DESCRIPTION OF THE INVENTION

As used herein, the term “suspension” means undissolved particles in a liquid.

Crude Zoledronic acid may be purified and made in a process that includes alkalization and re-acidification of an aqueous solution of Zoledronic acid. In particular, the process entails mixing crude Zoledronic acid in water, preferably 10-26 volumes of water per grams of zoledronic acid, more preferably 10-15 volumes of water per grams of zoledronic acid. The mixing may be done at room temperature. The pH of the mixture is adjusted until a clear solution having an alkaline pH, preferably between 9-12, is obtained. The pH of the mixture may be adjusted by adding a base such as sodium hydroxide, potassium hydroxide, etc. The alkaline solution is acidified, preferably to a pH of less than 2, more preferably to PH between 1-1.5. The solution may be acidified by adding an acid, such as HCl, preferably 32% aqueous HCl. The acid causes zoledronic acid to precipitate and the precipitate is isolated.

The impurity profile of the purified Zoledronic acid vs. crude Zoledronic acid is as follows:

| MS-425 (crude, no | |
|---|---|
| recrystallization | LB-295 (cryst.) |
| HPLC data (% on area) | HPLC data (% on area) |
| RRT 0.84 = 0.57% | RRT 0.84 = 0.08% |
| RRT 1.00 (ZLD-Ac¹) = 97.20% | RRT 1.00 (ZLD-Ac) = 99.60% |
| RRT 1.30 = 0.61% | RRT 1.30 = ND² |
| RRT 1.90 (IAA³) = 0.73% | RRT 1.90 (IAA) = ND |
| RRT 2.40 (Imidazole⁴) = 0.37% | RRT 2.40 (Imidazole) = ND |

Notes:
³IAA is the starting material for the preparation of Zoledronic acid
⁴Imidazole is the starting material for the preparation of IAA
¹ZLD-Ac = Zoledronic acid
²ND = not detected
HPLC method:

Column & Packing: Phenomenex, Luna 5 micron, Phenyl-Hexyl, 250*4.6

Eluent: 20% MeOH, 80% Buffer (990ml water, 10ml HClO₄ (˜70%), 1 ml H₃PO₄(˜85%), 40 mmole/L 1-octanesulfonic acid sodium salt)

Flow: 0.8 ml/min

Detection wave length: 220 nm

Column Temperature: 30 degrees C.

Diluent: 10% MeOH, 90% water

Sample concentration: 1 mg/1 ml diluent

Injection volume: 10 microlitter

The subject purification and the process for preparing zolendronic acid can also be performed on an industrial scale.

The inventive process is advantageous compared to a simple recrystallization of crude Zoledronic acid from water as the amount of water that is needed is significantly smaller (while a recrystallization process from water is performed at reflux temperature in order to achieve complete dissolution of the material in water). These two parameters may be even more significant when an industrial production is concerned.

### EXAMPLES

The present invention can be illustrated in one of its embodiments by the following non-limiting examples.

### Example 1

Crude Zoledronic acid (4 g) was suspended in water (40 ml) at room temperature. The pH of the suspension was adjusted to 9-10 by adding sodium hydroxide (pearls, 1.7 g) to obtain a clear solution. Then the pH of the solution was adjusted to 1-1.5 to obtain a massive precipitation of Zoledronic acid. The obtained suspension was cooled to 5° C. and was stirred at this temperature for an additional 2.5 hours. The product was then isolated by filtration, washed with water (1×10 ml) and dried in a vacuum oven at 50° C. for 22 hours to obtain 3.0 g (75%) of recrystallized Zoledronic acid monohydrate.

### Example 2

Zoledronic acid (200.0 g) was suspended in water (2000 ml) at room temperature. The pH of the suspension was adjusted to 14 by adding sodium hydroxide (pearls, 91.0 g) to obtain a clear solution. Then the pH of the solution was adjusted to 1 by adding 32% HCl (300 ml). The solution was cooled to 5° C. and was stirred at this temperature for 2.5 hours. A massive precipitate of Zoledronic acid was observed at 20° C. The product was then isolated by filtration, washed with water (3×100 ml) and dried in a vacuum oven at 50° C. for 1.5 hour and then in a vented oven at 65° C. for 24 hours to obtain 162.0 g (81%) of recrystallized Zoledronic acid.

Having thus described the invention with reference to particular preferred embodiments and illustrative examples, those in the art can appreciate modifications to the invention as described and illustrated that do not depart from the spirit and scope of the invention as disclosed in the specification. The Examples are set forth to aid in understanding the invention but are not intended to, and should not be construed to, limit its scope in any way. The examples do not include detailed descriptions of conventional methods. Such methods are well known to those of ordinary skill in the art and are described in numerous publications. All references mentioned herein are incorporated in their entirety.

What is claimed is:

1. A process for purifying zoledronic acid comprising
(a) raising the pH of an aqueous suspension of crude zoledronic acid until a clear solution is obtained;
(b) lowering the pH of the solution obtained in (a) until zoledronic acid precipitates out of solution; and
(c) isolating the zoledronic acid that has precipitated from the solution in (b).

2. The process of claim 1, wherein the suspension in (a) is formed by mixing 10-26 volumes of water per grams of zoledronic acid.

3. The process of claim 2, wherein the suspension in (a) is formed by mixing 10-15 volumes of water per grams of zoledronic acid.

4. The process of claim 1, wherein the mixing is done below reflux temperature.

5. The process of claim 4, wherein the mixing is done at room temperature.

6. The process of claim 1, wherein the pH of the suspension in (a) is raised to between about 9 to about 12.

7. The process of claim 1, wherein the pH of the suspension in (a) is raised by the addition of a base.

8. The process of claim 7, wherein the base is selected from the group consisting of sodium hydroxide and potassium hydroxide.

9. The process of claim 1, wherein the pH of the solution in (b) is lowered to less than about 2.

10. The process of claim 9, wherein the pH of the solution in (b) is lowered to between about 1 to about 1.5.

11. The process of claim 1, which is an industrial scale process.

12. In a process for preparing zoledronic acid, the steps of:
(a) raising the pH of an aqueous suspension of crude zoledronic acid until a clear solution is obtained;
(b) lowering the pH of the solution obtained in (a) until zoledronic acid precipitates out of solution; and
(c) isolating the zoledronic acid that has precipitated from the solution in (b).
